(19) United States
(12) Patent Application Publication
(10) Pub. No.: US 2012/0290678 A1
(43) Pub. Date: Nov. 15, 2012

(54) DYNAMIC, USER-DRIVEN SERVICE CATALOG

(75) Inventors: Christopher J. Dawson, Arlington, VA (US); Lydia M. Do, Raleigh, NC (US); Brian M. O'Connell, RTP, NC (US); James W. Seaman, Falls Church, VA (US)

(73) Assignee: INTERNATIONAL BUSINESS MACHINES CORPORATION, Armonk, NY (US)

(21) Appl. No.: 13/106,380

(22) Filed: May 12, 2011

(51) Int. Cl. G06F 15/16

(52) U.S. Cl. 709/217

(57) ABSTRACT

Embodiments of the invention are directed to a dynamic, user-driven service catalog based on real-time inputs by an end-user based on an automated evaluation process. Authorized end-users may directly submit services into the service catalog that are of value to the end-user, his/her peers, departments, groups, etc. Each service is analyzed to determine its viability as it matches an organization's cost and product offerings. This approach allows for more complex IT service models, wherein concurrent service requests can be compared, analyzed, and eventually fulfilled. Specifically, a catalog update tool provides this capability. The catalog update tool includes a plausibility engine configured to receive a request to add a service to a service catalog and evaluate whether the request can be added to the service catalog based on an analysis of system-integrated criteria. The catalog update tool further includes a cost engine to determine a cost for fulfilling the request, and a service request management module configured to add the service to the service catalog based on the analysis of system-integrated criteria and the cost for fulfilling the request.

### FIELD OF THE INVENTION

The present invention generally relates to information technology (IT) service catalogs. Specifically, the present invention relates to user-driven IT service catalogs.

### BACKGROUND OF THE INVENTION

The basic purpose of an IT catalog is to organize information on a collection of products, services, or information that may be of interest to individuals or groups. Catalogs may be structured lists or itemized displays of titles, offerings, or services for use or sale, and may include descriptive information or illustrations relative to the listed items. The IT service catalog is a solution that helps IT groups organize and distribute IT services they deliver to their business or business customers. An IT service catalog provides a list of standard IT service options and agreements that can be made available to customers. The components of the service catalog may include: 1) a description of the service; 2) service level agreements (SLA) for fulfilling the service, including timeframes, service levels, etc.; 3) authorization of who can request or view the service; 4) billing rates or other associated costs for the services; and 5) methods to fulfill the service.

Conventionally, management of service catalogs is centralized, such that, if a user desires a new function to be added to a service catalog, that user must submit a request, the request must be reviewed, a catalog administrator must create the catalog entry, and the end-user is notified that their request has been processed. However, current management approaches lack an analysis regarding the viability and value of the service entry to end-users and/or organizations.

### SUMMARY OF THE INVENTION

An approach that implements a dynamic, user-driven service catalog based on real-time inputs from an end-user is provided. Authorized end-users may directly submit services into the service catalog that are of value to the end-user, his/her peers, departments, groups, etc. Each service is analyzed to determine its viability as it matches an organization's cost and product offerings. This approach allows for more complex IT service models, wherein concurrent service requests can be compared, analyzed, and eventually fulfilled.

In one approach, there is a system for implementing a dynamic, user-driven service catalog. In this approach, the system comprises at least one processing unit, and memory operably associated with the at least one processing unit. A catalog update tool is storable in memory and executable by the at least one processing unit. The catalog update tool includes a plausibility engine configured to receive a request to add a service to a service catalog and evaluate whether the request can be added to the service catalog based on an analysis of system-integrated criteria. The catalog update tool further includes a cost engine to determine a cost for fulfilling the request and a service request management module configured to add the service to the service catalog based on the analysis of system-integrated criteria and the cost for fulfilling the request.

In another approach, there is a method for implementing a dynamic, user-driven service catalog. In this approach, the method comprises: receiving a request to add a service to a service catalog; evaluating whether the request can be added to the service catalog based on an analysis of system-integrated criteria; determining a cost for fulfilling the request; and adding the service to the catalog based on the evaluating and the determining.

In another approach, there is a computer-readable storage device storing computer instructions, which when executed, enables a computer system to implement a dynamic, user-driven service catalog, the computer instructions comprising: receiving a request to add a service to a service catalog; evaluating whether the request can be added to the service catalog based on an analysis of system-integrated criteria; determining a cost for fulfilling the request; and adding the service to the catalog based on the evaluating and the determining.

### BRIEF DESCRIPTION OF THE DRAWINGS

FIG. 1 shows a schematic of an exemplary computing environment in which elements of the present invention may operate;

FIG. 2 shows a catalog update tool that operates in the environment shown in FIG. 1; and

FIG. 3 shows a flow diagram of an approach for implementing a dynamic, user-driven service catalog according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Exemplary embodiments now will be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Embodiments of the invention are directed to a dynamic, user-driven service catalog that evaluates real-time inputs by an end-user. Authorized end-users may directly submit services into the service catalog that are of value to the end-user, his/her peers, departments, groups, etc. Each service is analyzed to determine its viability as it matches an organization's cost and product offerings. Specifically, a catalog update tool provides this capability. The catalog update tool includes a plausibility engine configured to receive a request to add a service to a service catalog and evaluate whether the request can be added to the service catalog based on an analysis of system-integrated criteria. The catalog update tool further includes a cost engine to determine a cost for fulfilling the request, and a service request management module configured to add the service to the service catalog based on the analysis of system-integrated criteria and the cost for fulfilling the request. This approach allows for more complex IT service models, wherein concurrent service requests can be compared, analyzed, and eventually fulfilled. Furthermore, the likelihood of catching errors (fault detection) is increased, and the reliance upon a time-consuming, centralized catalog administrator is reduced.

Unless specifically stated otherwise, it may be appreciated that terms used herein such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

Many of the functional units described in this specification have been labeled as modules, engines, portals, etc., in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network.

Furthermore, as will be described herein, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

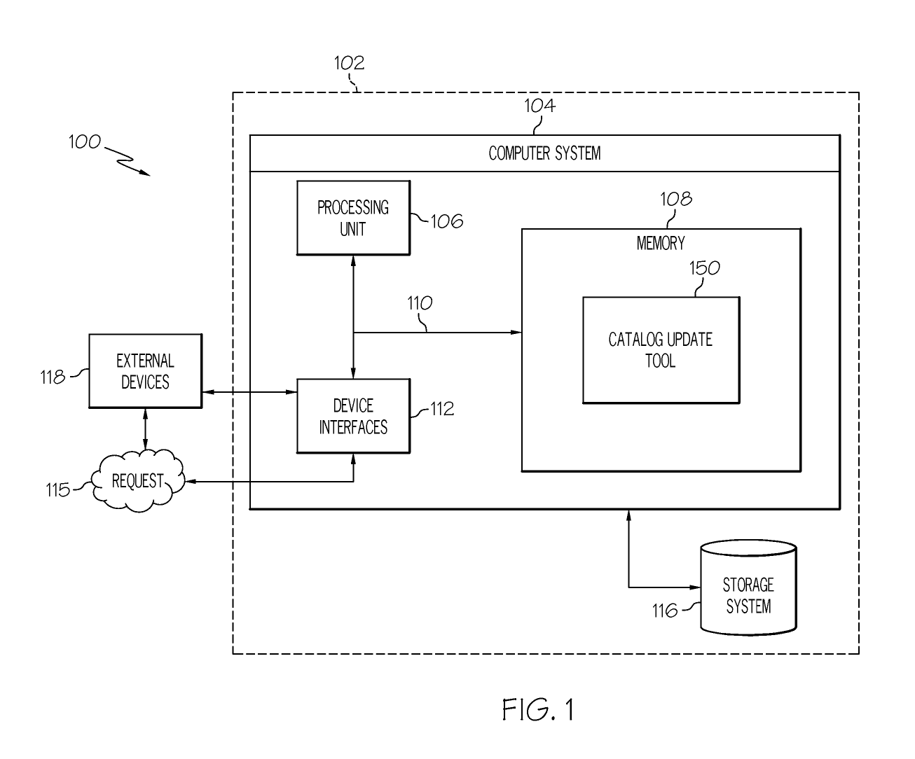

Turning now to FIG. 1 a computerized implementation 100 of the present invention will be described in greater detail. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for implementing a dynamic, user-driven service catalog. It should be understood that any other computers implemented under the present invention may have different components/software, but will perform similar functions. As shown, computer system 104 includes a processing unit 106 capable of receiving requests 115 and delivering them to memory 108. Also, shown is memory 108 for storing a catalog update tool 150, a bus 110, and device interfaces 112.

Processing unit 106 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 106 collects and routes signals representing outputs from external devices 118 (e.g., a graphical user interface operated by an end-user) to catalog update tool 150. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the video signals may be encrypted using, for example, trusted key-pair encryption. Different sensor systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating catalog update tool 150, which is stored in memory 108 and/or storage system 116. While executing computer program code, processing unit 106 can read and/or write data to/from memory 108 and storage system 116. Storage system 116 can include VCRs, DVRs, RAID arrays, USB hard drives, optical disk recorders, flash storage devices, and/or any other data processing and storage elements for storing and/or processing data. Although not shown, computer system 104 could also include I/O interfaces that communicate with one or more external devices 118 that enable an end-user to interact with computer system 104 (e.g., a keyboard, a pointing device, a display, etc.).

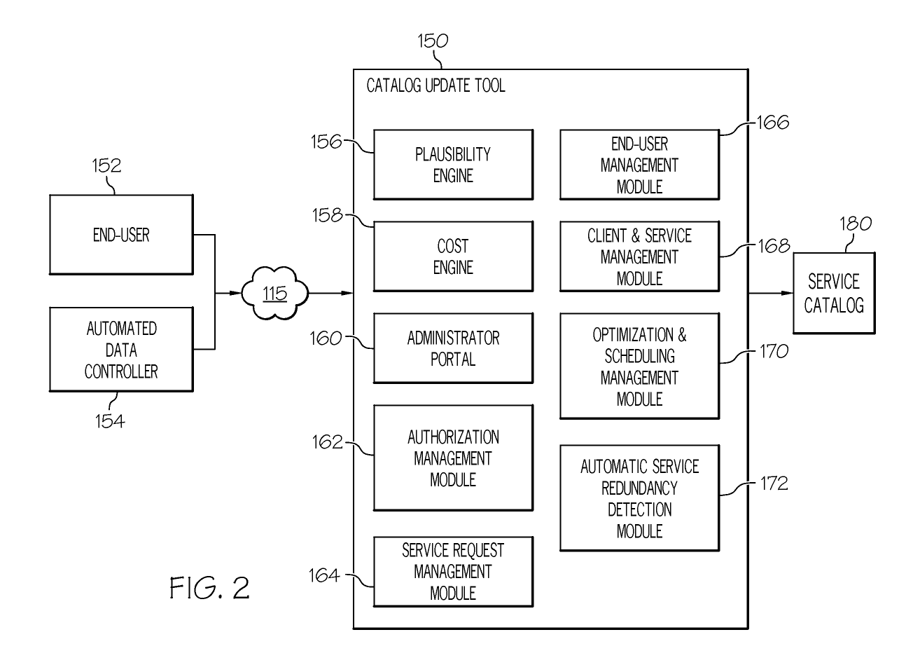

Turning now to FIG. 2, catalog update tool 150, which dynamically manages requests to integrate additional services into a service catalog, will be described in greater detail. As shown, catalog update tool 150 receives requests 115 to add a new service/function to a service catalog 180 directly from an end-user 152 and/or an automated data controller 154. End-user 152 is permitted to directly submit into service catalog 180 entries that are of value to him/her, peers, departments, groups, etc. Alternatively, requests 115 are automatically generated by automated data controller 154 based on customized data collected from end-user 152 or a group of users. That is, activities/patterns/behaviors of end-user 152 may be collected and used to create service requests of interest to end-user 152. In both cases, requests are capable of being submitted directly to service catalog 180, via catalog update tool 150, without needing to be approved by a centralized catalog administrator.

As shown, catalog update tool 150 comprises a plausibility engine 156, which receives request 115 to add a service to service catalog 180, and evaluates whether the request can be added to service catalog 180 based on an analysis of system-integrated criteria, including current product offerings of an organization. For example, the request requires ‘X,’ ‘Y,’ and ‘Z’ before it may be fulfilled. Plausibility engine 156 does a look-up to see if X, Y, and Z are within the constraints of the system. If so, request 115 is sent to cost engine 158, which is configured to determine a cost for fulfilling request 115. Cost engine 158 provides the function of determining whether the cost of a request/transaction exceeds a predetermined threshold resulting in an unprofitable outcome (e.g., [cost of request]<[revenue]−[operating costs]). In one embodiment, this determination by cost engine 158 is based on at least one of the following: an identity of end-user 152, and a complexity of request 115. For example, different end-users may have different on-going service level agreements (e.g., negotiated agreements between a service provider and a customer that formalizes a business relationship between the two parties) with an owner/operator of service catalog 180 such that “first-tier” clients would have a different cost threshold than a “third-tier” client. However, it will be appreciated that many approaches for determining whether the cost of a request/transaction exceeds a predetermined threshold are possible within the scope of the invention and that no single approach is dispositive.

As further shown, catalog update tool 150 comprises an administrative portal 160 configured to provide administrative control over request 115, and an authorization management module 162 configured to route request 115 to administrator portal 160 in the case that the request does not meet the system-integrated criteria. That is, authorization management module 162 receives complex requests/transactions that may not initially meet the criteria of plausibility engine 156, and routes them to administrator portal 160 for resolution. Administrator portal 160 provides administrative control into the system in order to selectively apply overrides, introduce new functionality, or manage issues that arise at plausibility engine 156. Accordingly, service requests that initially do not meet the requirements in place at plausibility engine 156 may nonetheless be submitted to service catalog 180 based on the determination at administrator portal 160.

As further shown, catalog update tool 150 additionally comprises a service request management module 164, which is configured to add the service to service catalog 180 based the analysis of system-integrated criteria and the cost for fulfilling request 115, as determined by plausibility engine 156 and cost engine 158, respectively. In one embodiment, service request management module 164 determines how a service request can be fulfilled, i.e., who can service the request, how the request is to be applied to service catalog 180, and what ultimately will be added to service catalog 180. For instance, depending on who can be matched to fulfill the request, service request management module 164 determines if there would be a billing rate change based on the division or person servicing the request. Cost engine 158 determines a target cost for request 115, which may be modified based on any number of factors, as well as through negotiation with end-user 152. To accomplish this, catalog update tool 150 comprises an end-user management module 166 configured to provide feedback to end-user 152 regarding the cost for fulfilling request 115, as well as a client & service management module 168, which allows negotiation regarding the cost for fulfilling request 115. These modules allow visibility to end-user 152 for achieving a desirable cost/budget, and a platform for negotiating costs based on client identity and service requirements. This enriches the functionality of cost engine 158 by accounting for dynamic service and business dependencies. Basic, task-level services may be negotiated at a relatively standard rate, whereas complex system-level services may be billed differently based on service level agreement and profit projections. For example, negotiations may take into account the identity of end-user 152, as well as other on-going SLAs currently active. In this case, first tier clients presumably would have better negotiating power than a third tier client.

In one embodiment, service request management module 164 evaluates request 115 based on scheduling requirements for fulfilling request 115, as well as an optimization of request 115 based on cost and feasibility of implementation. That is, the cost may still be adjusted based on the analysis performed by an optimization & scheduling management module 170, which is configured to evaluate request 115 based on information received from client & service management module 168 (e.g., cost negotiation information), service request management module 164 (e.g., cost, scheduling, and optimization requirements), and service catalog 180. Optimization & scheduling management module 170 is further configured to perform at least one of the following: remove stale requests from catalog update tool 150, and manage service catalog 180 based on changes to the fulfillment of a service.

Optimization & scheduling management module 170 operates with an automatic service redundancy detection module 172, which detects potentially redundant requests submitted to service catalog 180. This is particularly useful because it is possible for two or more end-users to add similar services to service catalog 180. For example, this may occur when two users associate a different name with a similar task, especially in large organizations that have employees located in different countries with different languages, resulting in different names for tasks. To minimize this, automatic service redundancy detection module 172 continuously analyzes and compares pending requests to existing requests/services. If a large enough duplication of tasks exists, end-user 152 is notified that another similar entry exists and may be presented with the option of examining that entry. In one embodiment, automatic service redundancy detection module 172 uses step order to help detect similar tasks/services.

It can be appreciated that the methodologies disclosed herein can be used within a computer system to implement a dynamic, user-driven service catalog, as shown in FIG. 1. In this case, catalog update tool 150 can be provided, and one or more systems for performing the processes described in the invention can be obtained and deployed to computer infrastructure 102. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

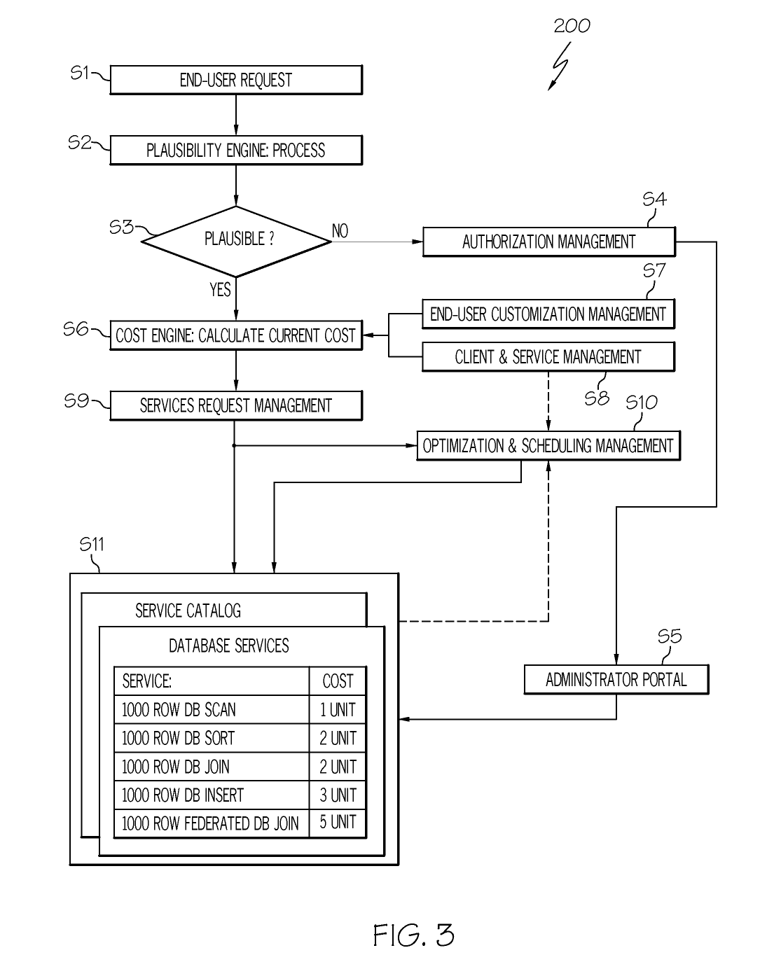

The program modules carry out the methodologies disclosed herein, as shown in FIG. 3. Shown is a method 200 for implementing a dynamic, user-driven service catalog, wherein, at 51, an end-user (or automated data controller) submits a request to add a service to a service catalog. At S2, the request is received at the plausibility engine and it is determined at S3 whether the request is plausible, i.e., whether the request can be added to the service catalog based on an analysis of system-integrated criteria. If no, the request is routed to the authorization management module (S4), which forwards the request to the administrator portal at S5. The administrator portal provides administrative control into the system in order to selectively apply overrides, introduce new functionality, or manage issues that arise at the plausibility engine. The request may be submitted to the service catalog based on the determination at the administrator portal.

Returning to S3, in the event that the request is plausible, it is passed to the cost engine at S6, which calculates the current cost for fulfilling the request, and determines whether the request exceeds a predetermined threshold. Cost is also established based on input from the end-user customization management module (S7), which provides feedback to the end-user regarding the cost, as well as client & service management module (S8), which facilitates negotiation of the cost for fulfilling the request. At S9, the request is received at the service request management module, which determines whether to add the service to the service catalog based on the cost for fulfilling the plausible request. The service request management module may send the request directly to the service catalog, or it may send the request to the optimization & scheduling management module at S10. Optimization & scheduling management module further evaluates the request based on information received from the client & service management module, the service request management module, and the service catalog. Finally, at S11, the request is received at the service catalog.

The flowchart of FIG. 3 illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order noted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations. For example, an implementation of exemplary computer system 104 (FIG. 1) may be stored on or transmitted across some form of computer readable media. Computer readable media can be any available media that can be accessed by a computer. By way of example, and not limitation, computer readable media may comprise “computer storage media” and “communications media.”

“Computer storage device” includes volatile and non-volatile, removable and non-removable computer storable media implemented in any method or technology for storage of information such as computer readable instructions, data structures, program modules, or other data. Computer storage device includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided an approach for implementing a dynamic, user-driven service catalog. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A system for implementing a dynamic, user-driven service catalog comprising:
at least one processing unit;
memory operably associated with the at least one processing unit; and
a catalog update tool storable in memory and executable by the at least one processing unit, the catalog update tool comprising:
a plausibility engine configured to:
receive a request to add a service to a service catalog; and
evaluate whether the request can be added to the service catalog based on an analysis of system-integrated criteria;
a cost engine configured to determine a cost for fulfilling the request; and
a service request management module configured to add the service to the service catalog based on the analysis of system-integrated criteria and the cost for fulfilling the request.

2. The catalog update tool according to claim 1, the plausibility engine further configured to receive the request from at least one of the following: an end-user, and an automated data controller.

3. The catalog update tool according to claim 2, the cost engine further configured to determine whether the cost of the request exceeds a predetermined threshold based on at least one of the following: an identity of the end-user, and a complexity of the service.

4. The catalog update tool according to claim 2, further comprising an end-user management module configured to provide feedback to the end-user regarding the cost for fulfilling the request.

5. The catalog update tool according to claim 1, the service request management module further configured to evaluate the request based on at least one of the following: the cost for fulfilling the request, scheduling requirements for fulfilling the request, and an optimization of the request.

6. The catalog update tool according to claim 1, further comprising:
an administrator portal configured to provide administrative control over the request; and
an authorization management module configured to route the request to the administrator portal in the case that the request does not meet the system-integrated criteria.

7. The catalog update tool according to claim 1, further comprising a client and service management module configured to allow negotiation regarding the cost for fulfilling the request.

8. The catalog update tool according to claim 1, further comprising:
an optimization and scheduling management module configured to:
evaluate the request based on information received from the client and service management module, the service request management module, and the service catalog; and
perform at least one of the following: remove stale requests from the catalog update tool, and manage the service catalog based on changes to the fulfillment of a service; and
an automatic service redundancy detection module configured to detect redundant requests submitted to the service catalog.

9. A method for implementing a dynamic, user-driven service catalog, comprising:
receiving a request to add a service to a service catalog;
evaluating whether the request can be added to the service catalog based on an analysis of system-integrated criteria;
determining a cost for fulfilling the request; and
adding the service to the service catalog based on the evaluating and the determining.

10. The method according to claim 9, wherein the request is submitted by at least one of the following: an end-user, and an automated data controller.

11. The method according to claim 10, the evaluating further comprising: determining whether the cost for fulfilling the request exceeds a predetermined threshold based on at least one of the following: an identity of the end-user submitting the request, and a complexity of the service.

12. The method according to claim 9, further comprising managing the service request based on at least one of the following: the cost of the request, scheduling requirements for fulfilling the request, and an optimization of the request.

13. The method according to claim 9, further comprising providing administrative control over the request in the case that the request fails to meet the system-integrated criteria.

14. The method according to claim 9, further comprising detecting redundant requests submitted to the service catalog.

15. The method according to claim 9, further comprising providing feedback to the end-user regarding the cost for fulfilling the request.

16. A computer-readable storage device storing computer instructions, which when executed, enables a computer system to implement a dynamic, user-driven service catalog, the computer instructions comprising:
receiving a request from an end-user to add a service to a service catalog;
evaluating whether the request can be added to the service catalog based on an analysis of system-integrated criteria;
determining a cost for fulfilling the request; and
adding the service to the service catalog based on the evaluating and the determining.

17. The computer-readable storage device according to claim 16 further comprising computer instructions for determining whether the cost for fulfilling the request exceeds a predetermined threshold based on at least one of the following: an identity of the end-user submitting the request, and a complexity of the service.

18. The computer-readable storage device according to claim 16 further comprising computer instructions for managing the service request based on at least one of the following: the cost of the request, scheduling requirements for fulfilling the request, and an optimization of the request.

19. The computer-readable storage device according to claim 16 further comprising computer instructions for providing administrative control over the request in the case that the request fails to meet the system-integrated criteria.

20. The computer-readable storage device according to claim 16 further comprising computer instructions for allowing negotiation regarding the cost for fulfilling the request.
